(19) United States
(12) Patent Application Publication
(10) Pub. No.: US 2011/0199198 A1
(43) Pub. Date: Aug. 18, 2011

(54) Method for operating a heads-up display system, heads-up display system

(76) Inventors: Yiwen Yang, Hildesheim (DE); Lutz Bersiner, Hildesheim (DE); Mario Mueller-Frahm, Hannover (DE); Moez Selem, Hannover (DE); Peter Vogel, Hildesheim (DE); Gerrit De Boer, Hildesheim (DE); Andreas Engelsberg, Hildesheim (DE); Holger Modler, Hildesheim (DE)

(21) Appl. No.: 12/931,725

(22) Filed: Feb. 8, 2011

(30) Foreign Application Priority Data
Feb. 9, 2010 (DE) 10 2010 001 684.5

(51) Int. Cl. B60R 25/10; G09G 5/00

(52) U.S. Cl. 340/426.25; 345/7

(57) ABSTRACT

In a method for operating a heads-up display system of a vehicle, the roadway state of the roadway to be traveled by the vehicle is checked using at least one suitable sensor, and a warning message is displayed at a location on the windshield in the case of detection of a critical roadway state, the location of the warning message corresponding to the dangerous, driving area of the roadway as viewed from the driver's perspective.

### BACKGROUND OF THE INVENTION

1. Field of the Invention

The present invention relates to a method for operating a heads-up display system of a vehicle, in particular a motor vehicle, in which the vehicle exterior, i.e., the vehicle surroundings, is monitored, and a warning message is displayed at the correct location on a windshield of the vehicle if a danger spot is detected. Furthermore, the present invention relates to a heads-up display system having first means for detecting a danger spot in the vehicle exterior and having second means for displaying a warning message at the correct location on a windshield of the vehicle, in particular the motor vehicle.

2. Description of Related Art

Heads-up display systems and methods for the operation thereof are known from the related art. Thus, there are heads-up display systems in which the vehicle exterior is monitored and in the event of detection of warning signs, speed limits, or objects on the roadway, for example, persons, animals, or vehicles, the detected objects are marked on the windshield using warning messages, which are overlaid or shown at the correct location. A corresponding heads-up display system is known, for example, from published German patent application document DE 101 31 720 A1. To support the driver during operation of the vehicle, the detected danger spots, which are also to be understood to include warning signs or speed limits in this case, are marked in such a way that from the viewpoint of the driver, the actual danger spots have the marking superimposed or framed by the marking, for example, i.e., are marked or shown in the correct location.

### BRIEF SUMMARY OF THE INVENTION

According to the present invention, the roadway state of the roadway to be traveled by the vehicle is checked using suitable sensors and in the event of detection of a critical roadway state, the roadway is at least regionally marked according to its state by display in the correct location. It is thus provided according to the present invention that the roadway state is detected. It is therefore preferably checked whether black ice, wet conditions, and/or unevenness, which disadvantageously influence the roadway state, are located on the roadway. If a critical roadway state, i.e., black ice, for example, is detected on the roadway, the roadway is marked, at least in the area in which the critical state was detected, by display in the correct location. It is provided that the marking gives a direct conclusion about whether the roadway state appears critical. The event which influences the roadway state may thus be indicated by a corresponding color and/or shape selection of the visual marking. As a result of the display in the correct location, the marking is superimposed on the roadway at the appropriate location from the viewpoint of the driver, so that the driver detects a direct spatial relationship between the marking and the actual danger spot, thus significantly reducing the driver's reaction time. The marking of critical roadway states supports the driver during driving operation so that he may reduce the vehicle speed, for example, in a timely manner before reaching the critical area of the roadway. As a result of the direct detection of the roadway states using the sensor or sensors, current and prompt detection of danger spots and corresponding marking of critical roadway states are always possible.

The roadway is advantageously scanned using at least one video camera, one laser scanner, one photo sensor having pixel depth information, one ultrasonic sensor, and/or one infrared sensor to detect the roadway state. Such sensors are oriented in the (forward) travel direction, in order to always detect the roadway state of the roadway to be traveled. One video camera having a stereo video sensor or two video cameras at a distance from one another are advantageously used, in order to determine the location of danger spots detected on the roadway in relation to the vehicle by triangulation, and in particular to prepare a three-dimensional model of the roadway course, in order to allow a corresponding overlay or display at the correct location on the windshield. Alternatively or additionally, the roadway state is scanned using the laser scanner, one or more laser units (LIDAR) scanning the surroundings here. The laser light is pulsed or modulated, and the runtime of the light beam and thus the distance to the reflection point are ascertained by phase comparison of the light reflected by the surroundings with a reference signal. This is advantageously performed for multiple points on one or more horizontal lines (scanning planes). The data detected by the different sensors are expediently analyzed in a computing unit (ECU) and advantageously also provided to further systems of the motor vehicle. Predictive suspension control or also automatic emergency braking may thus advantageously also be performed in the event of particularly critical obstructions as a function of the detected data.

In the event of detection of black ice on a roadway area, ice crystals are advantageously displayed at the correct location. The heads-up display system thus displays ice crystals, in particular two-dimensional ice crystal symbols, which identify the area in which the black ice was detected on the roadway. The ice crystals may be rapidly detected and comprehended by the driver of the vehicle, so that the driver reacts very rapidly to the warning and may reduce the speed of the vehicle, for example.

In the event of detection of wet conditions on the roadway area, raindrops are advantageously displayed at the correct location. Like the ice crystals, raindrops are also known to drivers of motor vehicles as a symbol for wet conditions or water/liquid on the roadway. The driver may thus decide very rapidly which critical roadway state is being displayed to him. In addition, it may be displayed to the driver on the basis of the density of the displayed raindrops or ice crystals how solid or thick the ice layer is, for example, and/or whether more or less water is located on the roadway.

Furthermore, it is alternatively or additionally provided that in the case of detection of unevenness in a roadway area, they are marked in the correct location, in particular accentuated by color. If critical unevenness is detected, these areas are displayed by the heads-up display in the windshield and marked using a warning color. In particular bumps, potholes, and/or curbs are detected as critical unevenness and displayed by the heads-up display system. The marking or warning color is superimposed on the real existing unevenness on the roadway, so that the driver may also detect it as equally real and drive around if needed. The height of bumps and/or the depth of potholes are advantageously indicated by different color intensities. It is also conceivable to display numbers in addition to the color marking, which show the actual height or depth of the unevenness and/or the distance of the danger spot from the vehicle.

Furthermore, upon detection of roadway narrowing, for example, in the area of a construction site, the roadway delimitation is displayed in the correct location, so that the driver may detect the roadway narrowing in particular in the event of poor vision conditions and react appropriately to the roadway narrowing, for example, by reducing the vehicle speed, before the vehicle reaches the roadway narrowing. In addition, objects located on the roadway, such as persons, vehicles, stones, tire parts, or similar objects, are advantageously also identified at the correct location using a visual marking.

The position and/or the orientation of the head and/or the eyes of the driver are preferably detected for the display in the correct location. Parallax errors resulting from movement of the driver's head or eyes may thus be compensated for. The position and/or orientation of the head and/or the eyes is/are considered during the calculation of the marking to be displayed. An interior sensor system, for example, having one or more video cameras, which detects the driver's head and measures or determines its position and/or orientation using suitable methods, for example, triangulation, may be used to measure the head position. It may be ensured by the thus possible display in the correct location or in the contact-analogous position that the displayed marking is always perceived by the driver directly over the real object, i.e., there is a fixed relationship to the real object.

The heads-up display system according to the present invention is distinguished in that the first means include at least one sensor for detecting the roadway state of the roadway to be traveled by the vehicle, and the second means are capable of at least regionally marking the roadway at the correct location on the windshield in accordance with the roadway state. This results in the above-described advantages.

The first means expediently include at least one laser scanner, one photo sensor having pixel depth information (PMD images; PMD=photonic mixer devices=imaging sensors having depth information for each pixel), one ultrasonic sensor, and/or one infrared sensor as sensors.

Finally, it is provided that the heads-up display system includes third means for detecting the position and/or orientation of the head and/or the eyes of the driver of the vehicle, in order to ensure the display or overlay of the marking of the state of the roadway in the correct location.

### BRIEF DESCRIPTION OF THE DRAWINGS

FIG. 1 shows a first exemplary embodiment in a schematic view.

FIG. 2 shows the first exemplary embodiment from the driver's perspective.

FIG. 3 shows the construction of an advantageous heads-up display system in a greatly simplified view.

FIG. 4 shows a further exemplary embodiment from the driver's perspective.

### DETAILED DESCRIPTION OF THE INVENTION

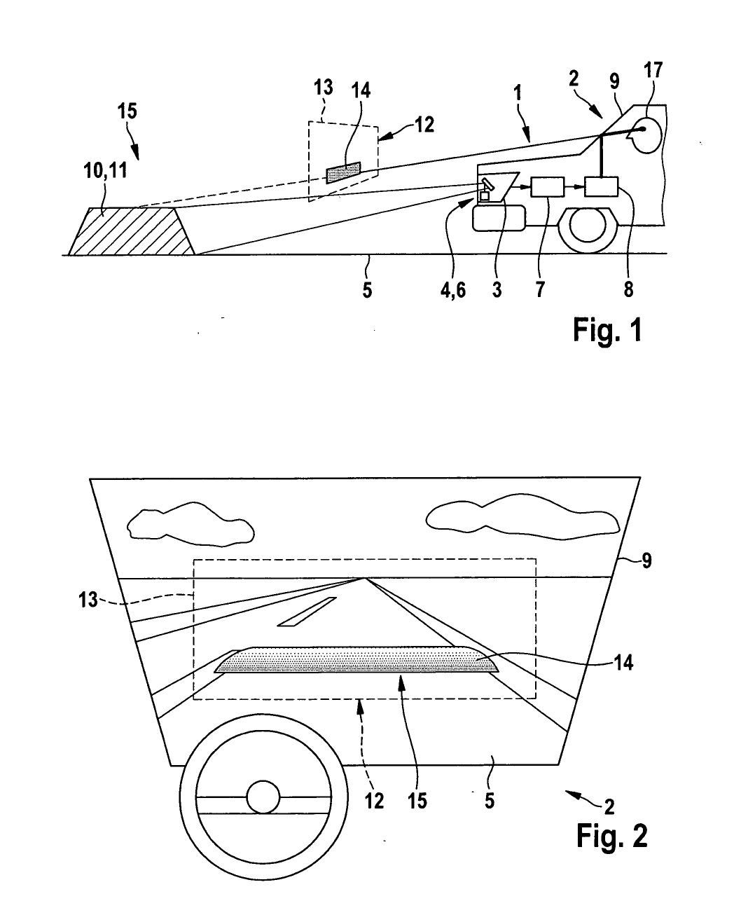

FIG. 1 shows a simplified view of an exemplary embodiment of an advantageous method for operating a heads-up display system 1 of a motor vehicle 2. In the present case, heads-up display system 1 includes first means 3 for detecting at least one danger spot in the vehicle exterior. For this purpose, the first means include a sensor 4, which scans the roadway state of roadway 5 to be traveled by vehicle 2. In the present exemplary embodiment, sensor 4 is implemented as a laser scanner 6, which includes one or more laser units (LIDAR sensor; light detection and ranging). Laser scanner 6 scans roadway 5 using pulsed and/or modulated laser light, the runtime of the beam and thus the distance to the reflection point being ascertained by a phase comparison of the light reflected by the surroundings with a reference signal. Laser scanner 6 is oriented in such a way that it scans the roadway in a state sufficiently far from motor vehicle 2 so that the driver still has sufficient time to initiate a braking action after detection of a danger spot. The orientation of sensor 4 may optionally be adapted to the speed of motor vehicle 2, in order to always ensure a sufficient reaction time for the driver.

Furthermore, heads-up display system 1 includes a control unit 7, which analyzes the data detected by sensor 4 or by laser scanner 6, and second means 8, which are used for the display of the detected danger spot in the correct location on a windshield 9 of motor vehicle 2. Second means 8 expediently include a projector, which is typical in a heads-up display, and which projects an image on the interior of windshield 9. The driver of the motor vehicle sees the image floating freely in front of the vehicle.

In the present exemplary embodiment, roadway 5 has an unevenness 10, which is formed by a bump 11. Bump 11 is shown disproportionately large in this case for reasons of visibility. If sensor 4 or laser scanner 6 detects bump 11, it transfers the data relating to the type of unevenness 10 and the location of unevenness 10 in relation to motor vehicle 2 to a control unit 7. The location of unevenness 10 may be determined, for example, by triangulation and appropriately situated laser units of laser scanner 6. Control unit 7 calculates the position and shape of unevenness 10. Furthermore, control unit 7 or optionally a further control unit of second means 8 determines whether and how unevenness 10 is to be marked. This may be a function of user settings and/or driving situations. The marking is displayed at the correct location on windshield 9 using the projector of second means 8, so that a marking 12 superimposed on real unevenness 10 appears to the driver at a specific distance in front of the vehicle. In the present exemplary embodiment, bump 11 is framed by a dashed line 13 and additionally marked or superimposed by a color bar 14. Color bar 14 advantageously has a warning color, the warning color preferably being selected as a function of the height of bump 11 or the size of unevenness 10. In the present case, color bar 14 has a graduated color curve, color bar 14 merging from black into red from bottom to top. The shape of the color bar particularly preferably essentially corresponds to the shape of bump. 11. A corresponding procedure is used if a pothole is located as unevenness 10 in roadway 5 instead of bump 11, the corresponding marking advantageously then having a different warning color, which indicates the depression in roadway 5. It is also conceivable to show an arrow pointing upward or downward adjacent to the marking to indicate to the driver whether unevenness 10 is a protrusion or a depression in roadway 5.

FIG. 2 shows the view through windshield 9 from the viewpoint of the driver of motor vehicle 2. Color bar 14 is superimposed on bump 11 and is additionally bordered here by dotted line 13. The display or marking in the correct location or the contact-analogous position of danger spot 15, which is formed in the present case by unevenness 10, gives the driver a direct relationship from the visual warning message to the real existing danger spot, so that the driver may decide in a short time how to react to the danger spot. Instead of or in addition to above-described laser scanner 6, one or more video cameras, one or more photo sensors having pixel depth information, one or more ultrasonic sensors, and/or one or more infrared sensors may also be used as sensor 4, in order to predictively scan roadway 5.

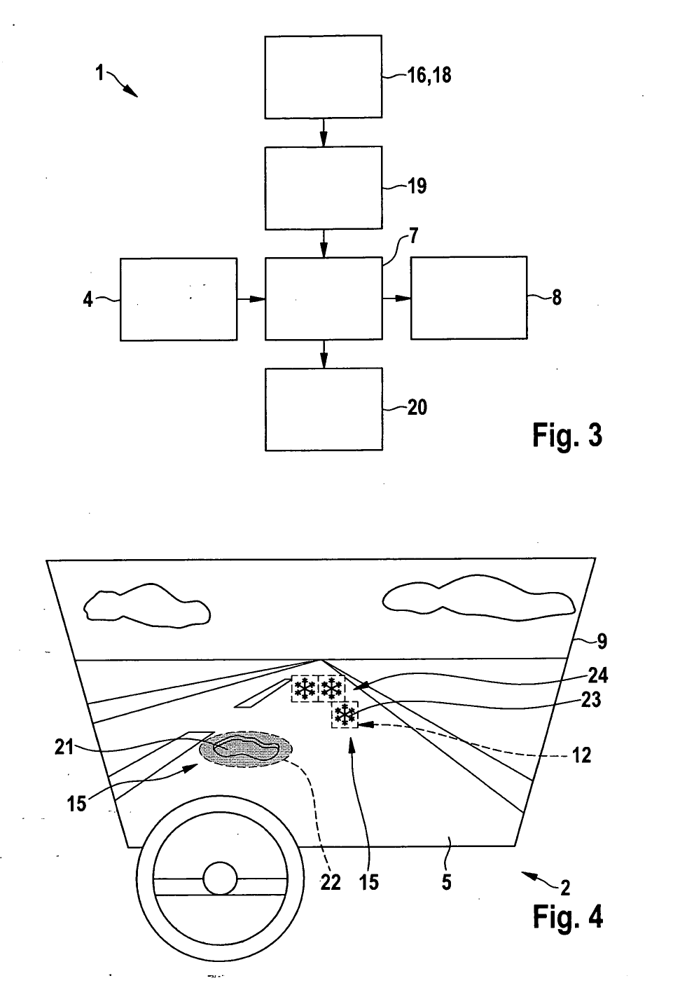

FIG. 3 shows a block diagram of an exemplary embodiment of a fundamental construction of advantageous heads-up display system 1. The elements known from FIG. 1 are provided with identical reference numerals, so that reference is made to the above description in this regard. Sensor 4, which may include laser scanner 6 and/or the other possible above-described sensors, relays the detected data, as already shown in FIG. 1, to control unit 7, which in turn activates second means 8 or the projector of heads-up display system 1. As already noted, second means 8 may also include a further control unit or computing unit, which determines, as a function of the analysis of control unit 7, whether and how a danger spot is to be marked. Furthermore, heads-up display system 1 includes third means 16 for detecting the position and/or orientation of head 17, as shown in FIG. 1, and/or the eyes of the driver of motor vehicle 2. The third means include an interior sensor system 18 for this purpose, which advantageously includes one or two video cameras, which are oriented toward driver's head 17, in order to detect its position and orientation. The position and orientation of the driver's head may thus be determined by suitable methods of image processing by a computing unit 19 and the marking may be overlaid or displayed at a corresponding position on windshield 9 as a function thereof.

Finally, a further control unit 20, which is a component of a suspension control system of motor vehicle 2, for example, is associated with heads-up display system 1. Control unit 20 also receives the data of control unit 7, and may perform a predictive control of the suspension on the basis of the data, so that optimum driving comfort is achieved, for example. The data of control unit 7 may also be used for a safety system, which may initiate automatic emergency braking upon detection of a very critical danger spot.

FIG. 4 shows a further advantageous exemplary embodiment for operating heads-up display system 1, as was described above. In this exemplary embodiment, a pothole 21 was detected on roadway 5 and identified by an oval color marking 22. The driver may thus still avoid pothole 21 in a timely manner in the event of poor weather conditions in this way. Furthermore, ice crystals 23 or ice crystal symbols are shown in the area of roadway 5 in which black ice 24 was detected on roadway 5 using sensors 4. The driver may immediately conclude that danger spot 15 is black ice 24 on the basis of the type of the display. The driver may reduce the vehicle speed accordingly. If the area of roadway 5 is only wet, raindrops may be shown instead of ice crystals 23, for example. Ice crystals 23 and/or the raindrops are expediently shown closer together as the danger due to black ice or wet conditions on roadway 5 increases. Snow on the roadway may also be indicated using the ice crystals, the ice crystals for snow preferably differing in color, for example, from those for black ice.

Overall, the display of the roadway states in the correct location offers the driver the possibility of reacting particularly rapidly to given danger spots, if the driver has not already detected them because of bad weather, for example. In particular in the event of black ice or wet conditions on the roadway, it is frequently difficult for the driver to recognize these danger spots. Because the marking is directly superimposed on real existing danger spots 15, the position of the danger spot is clearly communicated to the driver, so that the driver may estimate rapidly how to react to avoid a danger situation or an accident.

In addition to the marking, the warning message may also optionally be supported or supplemented by an acoustic signal.

What is claimed is:

1. A method for operating a heads-up display system of a vehicle to aid a driver of the vehicle, comprising:
monitoring, using at least one sensor system, the state of a roadway to be traveled by the vehicle; and
visually displaying a warning message on a windshield of the vehicle if the roadway is determined to present a dangerous driving area, wherein the warning message is displayed at a location on the windshield corresponding to the dangerous driving area of the roadway as viewed from the driver's perspective.

2. The method as recited in claim 1, wherein the monitoring of the state of the roadway includes scanning the roadway using at least one of a video camera, a laser scanner, a photo sensor having pixel depth information, an ultrasonic sensor, and an infrared sensor.

3. The method as recited in claim 2, wherein the dangerous driving area is an area covered with black ice, and the warning message is an ice crystal symbol.

4. The method as recited in claim 2, wherein the dangerous driving area is an area covered with rain, and the warning message is a raindrop symbol.

5. The method as recited in claim 2, wherein the dangerous driving area is an area of unevenness, and the warning message is accentuated by color.

6. The method as recited in claim 2, wherein the dangerous driving area is an area of roadway narrowing.

7. The method as recited in claim 2, further comprising:
detecting at least one of a position and orientation of at least one of a head of the driver and eyes of the driver, and wherein the at least one of the position and orientation is considered in determining the display location of the warning message.

8. A heads-up display system of a vehicle configured to aid a driver of the vehicle, comprising:
at least one sensor system configured to monitor the state of a roadway to be traveled by the vehicle; and
a visual display system configured to display a warning message on a windshield of the vehicle if the roadway is determined to present a dangerous driving area, wherein the warning message is displayed at a location on the windshield corresponding to the dangerous driving area of the roadway as viewed from the driver's perspective.

9. The heads-up display system as recited in claim 8, wherein the at least one sensor system includes a laser scanner, a photo sensor having pixel depth information, an ultrasonic sensor, and an infrared sensor.

10. The heads-up display system as recited in claim 9, further comprising:
a detection unit configured to detect at least one of a position and orientation of at least one of a head of the driver and eyes of the driver, and wherein the at least one of the position and orientation is considered in determining the display location of the warning message.
